(19) United States
(12) Patent Application Publication
(10) Pub. No.: US 2007/0230480 A1
(43) Pub. Date: Oct. 4, 2007

(54) Method and system for controlling quality of service of IP packet in passive optical network system

(76) Inventors: Hiroki Ikeda, Hachioji (JP); Nie Yaling, Beijing (CN)

Correspondence Address: REED SMITH LLP;Suite 1400, 3110 Fairview Park Drive, Falls Church, VA, 22042, US

(21) Appl. No.: 11/727,366

(22) Filed: Mar. 26, 2007

(30) Foreign Application Priority Data
Mar. 31, 2006 (CN) 2006-10071064.6

(51) Int. Cl. H04L 12/56

(52) U.S. Cl. 370/395.52; 370/425

(57) ABSTRACT

A method and system for controlling service of quality of an IP packet in a passive optical network system. An optical line terminal (OLT) in the passive optical network system having an optical distribution network (ODN) and at least one optical network unit (ONU), has a processing unit for determining QoS, i.e., a priority order, at a PON layer in accordance with IP layer information of received data, and assigning a LINK ID to the data. Accordingly, quality of service of data at a network layer can be mapped to quality of service of data at a physical layer and quality of service of an IP data stream in the PON system can be controlled to thereby ensure the quality of transfer of the IP data stream in the passive network system.

### INCORPORATION BY REFERENCE

The present application claims priority from Japanese application CN200610071064.6 filed on Mar. 31, 2006, the content of which is hereby incorporated by reference into this application.

### BACKGROUND OF THE INVENTION

1. Field of the Invention

The present invention relates to a method and system for controlling quality of service of IP packets in a passive optical network system to allow quality of service of transfer of IP packets to be ensured in the passive optical network system.

2. Description of the Related Art

In present information societies, a passive optical network (PON) system is most advanced technologies of the fiber to the x in optical fiber access technologies. Generally, the passive optical network (PON) system includes an optical line terminal (OLT), an optical network unit (ONU) and an optical distribution network (ODN) to present a broadband access method to end users, and have many advantages over present other broadband access technologies. The most remarkable advantages reside in that the passive optical network system, e.g., a GPON system, can present an access speed of gigabit level to end users, and can deal with broadband network applications of end users more properly.

An Internet Protocol (IP) network presents audio and data services and many other video services such as operations called “triple play”. In the triple play operations, a network television (Internet Protocol Television (IPTV)) is one of most important broadband applications.

IPTV requires a broader band both in a core network and an access network. Generally, band resources are effectively utilized by multicast technologies for a PON system.

Video operations are very sensitive to delay, jitter and packet loss so that controlling quality of service (QoS) is important techniques for supplying IPTV operations.

FIG. 1 is a schematic diagram illustrating conventional IP packet transfer with ensured QoS and analyzing a conventional QoS control state from the viewpoint of a protocol stack. FIG. 1 shows a protocol stack of an IPTV server, a multicast router, an OLT, an ONU, and a television (TV).

As shown in FIG. 1, in order to realize QoS transfer from the IPTV server to the television, QoS control is performed at the IP layer. Since all of the IPTV server, multicast router and television include the IP layer protocol, it is possible for all of the IPTV server, multicast router and television to ensure QoS at the IP layer. However, the OLT node and ONU node do not have the IP layer protocol in the protocol stack. Namely, these nodes cannot deal with QoS control at the IP layer. Therefore, although the OLT and ONU nodes can deal with QoS control relying upon optical data on the physical layer protocol stack, QoS control of data cannot be ensured if collision occurs while data passes through the OLD and ONU nodes.

As described above, although IP packets are required to be transferred with ensured QoS at the IP layer (the third layer of the OSI model) in the whole system, the OLT and ONU nodes in the PON system can perform QoS control relying upon optical data only on the physical layer (the first layer of the OSI model) protocol stack. Therefore, QoS control of IP packets cannot be performed partially in the whole PON system.

JP-A-2003-134156discloses the technique of setting a priority order in accordance with IP layer information such as a transmission source address, a transmission destination address, a transmission source port number, respectively of an IP packet, a protocol and the like, and executing a priority process of a packet from a particular user terminal. According to this Official Gazette, the priority control relying upon the IP layer information cannot be executed in an optical access network (e.g., PON). In other words, this Official Gazette is also associated with the problem that QoS control of IP packets cannot be performed in the PON system.

### SUMMARY OF THE INVENTION

The present invention has been made in view of the above-described problem. An object of the present invention is to provide an optical line terminal, a passive optical network system having the optical line terminal, and a method of controlling quality of service of IP packets in the passive optical network, and to ensure quality of service of data transfer in the passive optical network system by mapping quality of service of data at the network layer to quality of service of data at the physical layer.

In order to achieve the above object of the present invention, there is provided an optical line terminal (OLT) in a passive optical network (PON) system having an optical distribution network (ODN) and at least one optical network unit (ONU), comprising: a processing unit for determining QoS, i.e., a priority order, at a PON layer in accordance with IP layer information of received data, and assigning a LINK ID to the data. The IP layer information is a reception address and/or QoS at an IP layer, and the reception address is a multicast group address.

The optical line terminal in a passive optical network further comprises an operation interface to be used for data transmission/reception relative to an external network or a server and an ODN interface for receiving data assigned with the LINK ID by the processing unit, performing a priority order control in accordance with the LINK ID, and transmitting the data to the optical distribution network.

In the optical line terminal in a passive optical network, the processing unit further comprises a proper combination of: an IP layer analysis module for analyzing an IP message header of the received data, extracting a reception address and/or QoS at an IP layer as the IP layer information, as if the received data is multicast data, extracting QoS at the IP layer in the IP message header as the IP layer information; a LINK ID assignment module for assigning a priority order assigning LINK ID to the data in accordance with the extracted IP layer information; an IGMP snooping module for snooping an IGMP message in the received data and extracting a multicast group address in the IGMP message as the IP layer information; and a LINK ID assignment module for assigning a priority order assigning LINK ID to the data.

The optical line terminal in a passive optical network further comprises an IP layer information—LINK ID table for storing a correspondence among the IP layer information of the received data, the LINK ID and QoS at the PON layer.

According to another aspect of the present invention, there is provided an optical line terminal in a passive optical network (PON) system having an optical distribution network (ODN) and at least one optical network unit (ONU), wherein: the optical line terminal comprises a memory, an operation interface for receiving an IP packet, a processing unit for generating a PON frame by adding a LINK ID representative of a transmission destination ONU to the IP packet, and an ODN interface for transmitting the PON frame; the memory has a table for storing a correspondence among IP layer information, a transfer priority order, i.e., QoS, of the PON frame, and the LINK ID; the processing unit detects header information of a received IP packet, determines a transfer priority order and the LINK ID of the PON frame for the IP packet, in accordance with the header information and the table, and generates the PON frame by adding the LINK ID; and the ODN Interface transmits the PON frame in accordance with the transfer priority order corresponding to the LINK ID of the PON frame.

In order to achieve the above object of the present invention, there is provided a method of controlling quality of service of an IP packet in a passive optical network system having an optical distribution network (ODN), an optical line terminal (OLT) and at least one optical network unit (ONU), the method comprising a step of: (a) determining QoS, i.e., a priority order, at a PON layer in accordance with IP layer information of received data, and assigning a LINK ID to the data. The IP layer information is a reception address and/or QoS at an IP Layer, and the reception address is a multicast group address.

The method of controlling quality of service of an IP packet in a passive optical network further comprises steps corresponding to the constituent elements of the optical line terminal in the above-described passive optical network system.

In order to achieve the above object of the present invention, there is provided a passive optical network system having an optical distribution network (ODN), an optical line terminal (OLT) and at least one optical network unit (ONU), wherein the optical line terminal comprises at least a processing unit for determining QoS, i.e., a priority order, at a PON layer in accordance with IP layer information of received data, and assigning a LINK ID to the data.

The passive optical network system further comprises constituent elements corresponding to the constituent elements of the optical line terminal of the above-described passive optical network system.

In the optical line terminal, passive optical network system having the optical line terminal, and method of controlling quality of service of an IP network in the passive optical network system of the present invention, quality of service of data at a network layer can be mapped to quality of service of data at a physical layer and quality of service of an IP data stream in the PON system can be controlled to thereby ensure the quality of transfer of the IP data stream in the passive network system. Remarkable advantages are therefore provided.

### BRIEF DESCRIPTION OF THE DRAWINGS

FIG. 1 is a schematic diagram illustrating IP packet transfer with ensured QoS according to conventional techniques.

FIG. 2 is a block diagram showing the structure of a PON system according to a first embodiment of the present invention.

FIG. 3 is a schematic diagram showing assembly of an Ethernet packet for an IP packet in a passive optical network.

FIG. 4 is a diagram showing an IP layer information—LLID table for QoS control relying upon a ToS value according to a modification of the first embodiment of the present invention.

FIG. 5 is a diagram showing an IP layer information—LLID table for QoS control relying upon a transmission destination address according to a modification of the first embodiment of the present invention.

FIG. 6 is a diagram showing an IP layer information—LLID table for QoS control relying upon a transmission destination address and a ToS value according to a modification of the first embodiment of the present invention.

FIG. 7 is a block diagram showing the structure of an OLT of a PON system according to a second embodiment of the present invention.

FIG. 8 is a diagram showing an IP layer information—LLID table for QoS control relying upon a multicast group address according to the second embodiment of the present invention.

FIG. 9 is a block diagram showing the structure of an OLT of a PON system according to a third embodiment of the present invention.

FIG. 10 is a diagram showing an IP layer information—LLID table for QoS control relying upon a multicast group address and a ToS value according to the third embodiment of the present invention.

FIG. 11 is a flow chart illustrating a quality of service control method for IP packets in a passive optical network system according to a fourth embodiment of the present invention.

FIG. 12 is a message flow of the whole system of the present invention.

FIG. 13 is a schematic diagram showing analysis of a QoS control state of the present invention made from the viewpoint of a protocol stack.

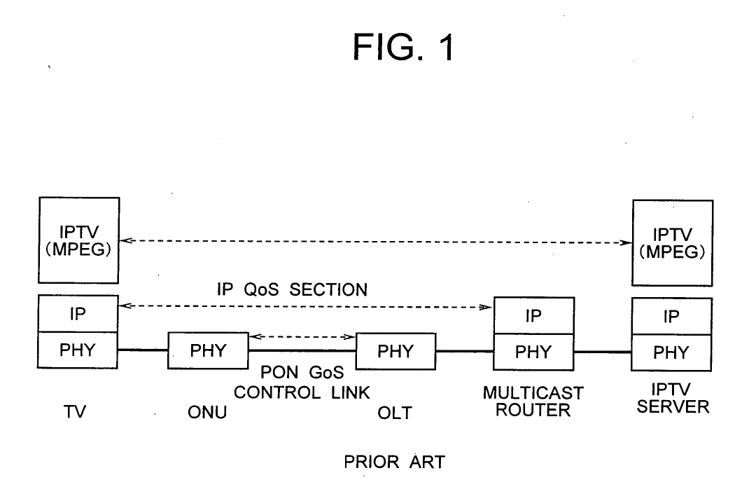

### DESCRIPTION OF THE EMBODIMENTS

With reference to the accompanying drawings, description will now be made on embodiments of the present invention.

### First embodiment

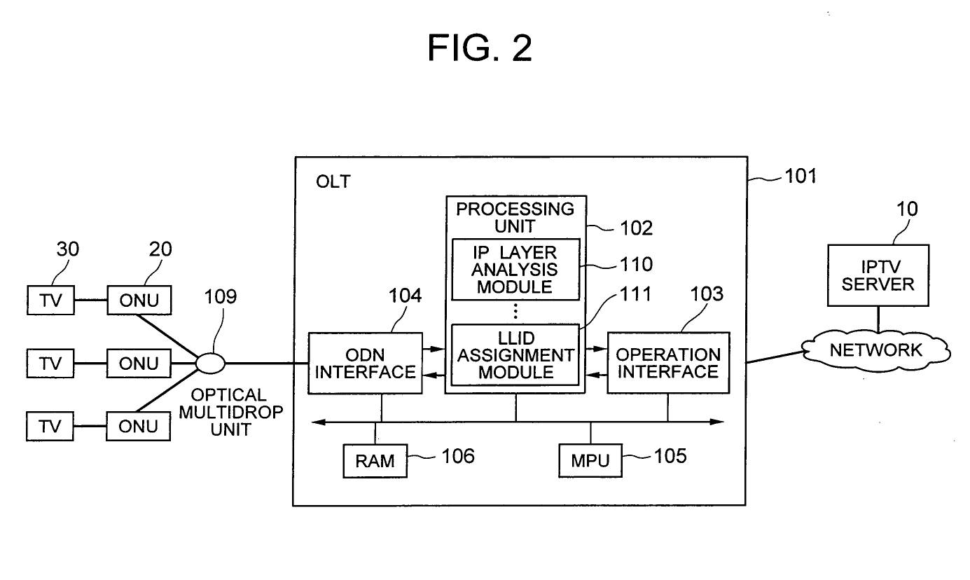

FIG. 2 is a block diagram showing the structure of a PON system according to the first embodiment of the present invention. The first embodiment shown in FIG. 2 is applied to a network in which a communication administrator does not set an operation priority order, but an ISP sets an operation priority order.

As shown in FIG. 2, the whole system includes an IPTV server 10, a passive optical network (PON) system, and networks for interconnection. The PON system includes an optical line terminal (OLT) 101, an optical network unit (ONU) 20 and an optical multidrop unit 109 as an optical distribution network (ODN).

The IPTV server 10 supplies IPTV services to end users of the PON system via a network. An end user requests data from the IPTV server 10 via ONU 20, optical multidrop unit 109, optical line terminal 101 and network. The IPTV server 10 transmits data to the end user via the network, optical line terminal 101, optical multidrop unit 109 and ONU 20. A television terminal (TV) 30 on the user side provides a television program converted from the received data to the end user.

Description will now be made on a frame structure of data (also called optical data or a PON frame) to be transferred in a PON system, by taking an EPON as an example.

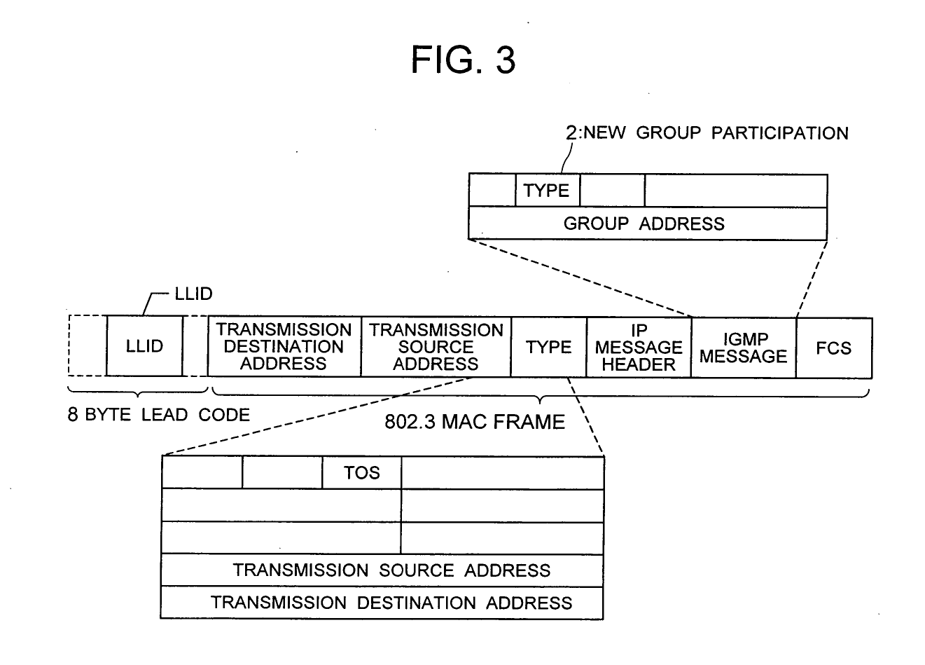

FIG. 3 is a schematic diagram showing the frame structure of an IP packet assembled into an Ethernet packet in PON. As shown in FIG. 3, a packet of a 802.3MAC frame includes a logical link identifier (LLID), an IP message header and an IGMP message. The Ip message header includes a TOS as QoS at the IP layer and a transmission destination address as a reception address, and the IGMP message includes a type and a group address.

Next, reverting to FIG. 2, description will be made on the structure of OLT 101 of the PON system shown in FIG. 2.

OLT 101 includes an operation interface 103, a processing unit 102, an ODN interface 104, a random access memory (RAM) 106 and a microprocessor 105.

The operation interface 103 is connected to an external network and is used for communications and data transmission/reception relative to the network.

The processing unit 102 processes data supplied from the operation interface 103 and ODN interface 104, determines QoS, i.e., a priority order, at the PON layer in accordance with IP layer information of data received via the operation interface 103, and assigns LLID representative of a transmission destination ONU to the received data. The processing unit 102 includes an IP layer analysis module 110 and an LLID assignment module 111.

The IP layer analysis module 110 of the processing unit 102 is used for analyzing the IP message header of the received data and extracting IP layer information of the data from the IP message header. For example, “TOS” and “transmission destination address” are extracted as IP layer information from the IP header of optical data shown in FIG. 3.

In accordance with the IP layer information such as extracted “TOS” and “transmission destination address”, the LLID assignment module 111 of the processing unit 102 assigns an optical priority order assigning LLID to the packet.

The ODN interface 104 transmits optical data received from ONU 20 and processed by the processing unit 102, i.e., an LLID added PON frame, to ONU 20 in accordance with a transfer priority order corresponding to LLID of the PON frame to thereby control the optical priority order.

The random access memory 106 stores data under operation by OLT 101.

The microprocessor 105 is used for controlling the operation of each unit module in the optical line terminal, for example, in order to make cooperate each unit module such as the operation interface 103, processing unit 102, ODN interface 104 and random access memory 106.

As described above, in the PON system, OLT 101 receives data transmitted from an upper level network and IPTV server 10 via the operation interface 103, the IP layer analysis module 110 of the processing unit 102 extracts IP layer information including the TOS value and/or transmission destination address and the like, to transfer data. The LLID assignment module 111 sets LLID and a corresponding LLID priority order of the message in accordance with a QoS parameter, and thereafter transmits the processed data to the ODN interface 104. In this manner, quality of service of data at the network layer is mapped to quality of service of data at the optical transfer layer (physical layer) in accordance with the IP layer information of the data so that quality of service of an IP data stream in the PON system can be controlled. It is therefore possible to ensure the transfer quality of an IP data stream in the PON system.

### Modification of First Embodiment

An example of OLT 101 of the first embodiment of the present invention has been described. The present invention is not limited thereto, but those skilled in the art may make various modifications in accordance with particular situations. A modification of the first embodiment will now be described.

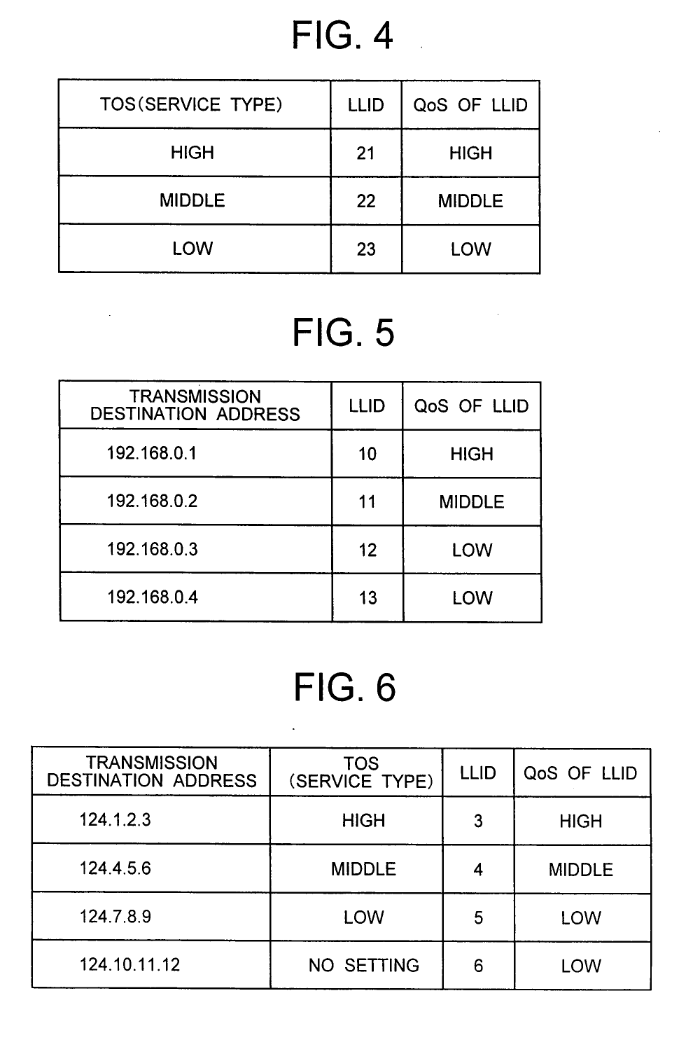

The random access memory 106 of OLT 101 of the first embodiment of the present invention stores data under operation by OLT 101. The random access memory 106 may store, for example, an IP layer information—LLID table. The IP layer information—LLID table stores a correspondence among the IP layer information of received data, corresponding LLID and QoS at the PON layer assigned to the data in accordance with the IP layer information. Examples of the IP layer information—LLID table are shown in FIGS. 4 to 6.

FIG. 4 shows the Ip layer information—LLID table for QoS control relying upon a ToS value, stored in the random access memory 106 of OLT 101 shown in FIG. 2, according to a modification of the first embodiment. The IP layer information—LLID table includes three items: “ToS value”, “LLID” and “QoS of LLID”. As shown in FIG. 4, if the “ToS value” of data received at OLT 101 is “high”, the LLID assignment module 111 assigns “21” to the data as LLID and determines that the priority order of LLID “21” is “high”, in accordance with predetermined rules.

FIG. 5 shows the Ip layer information—LLID table for QoS control relying upon a transmission destination address, stored in the random access memory 106 of OLT 101 shown in FIG. 2, according to a modification of the first embodiment. The IP layer information—LLID table includes three items: “transmission destination address”, “LLID” and “QoS of LLID”. As shown in FIG. 5, if the “transmission destination address”, i.e., reception address, of data received at OLT 101 is “192.168.0.1”, the LLID assignment module 111 assigns “10” to the data as LLID and determines that the priority order of LLID “10” is “high”, in accordance with predetermined rules.

FIG. 6 shows the Ip layer information—LLID table for QoS control relying upon a transmission destination address and a ToS value, stored in the random access memory 106 of OLT 101 shown in FIG. 2, according to a modification of the first embodiment. The IP layer information—LLID table includes four items: “transmission destination address”, “ToS value” “LLID” and “QoS of LLID”. As shown in FIG. 6, if the “transmission destination address” of data received at OLT 101 is “124.1.2.3” and the ToS value is “high”, the LLID assignment module 111 assigns “3” to the data as LLID and determines that the priority order of LLID “3” is “high”, in accordance with predetermined rules.

It is obvious that the orders of assigning LLID and determining QoS of LLID may be the same or may vary with circumstances. The predetermined rules may be determined by a system administrator.

### Second Embodiment

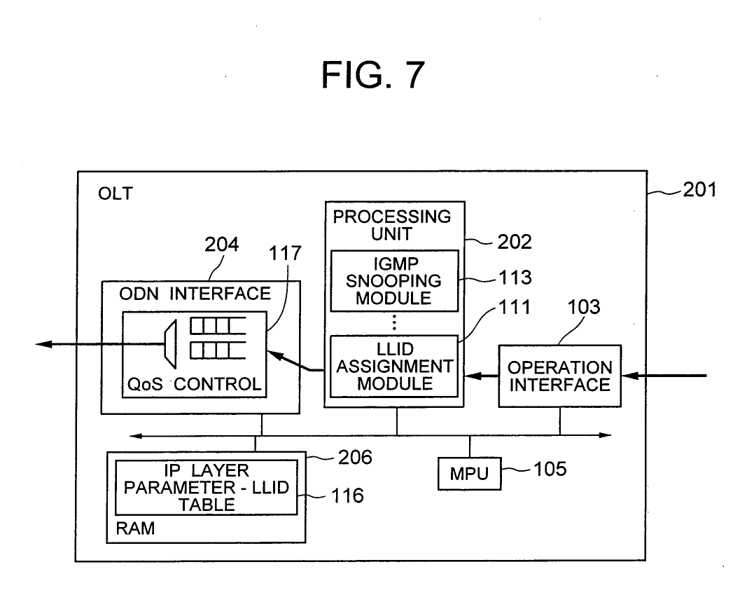

FIG. 7 is a block diagram showing the structure of OLT of a PON system according to the second embodiment of the present invention. The second embodiment shown in FIG. 7 is applied to a network in which an ISP does not set an operation priority order, but a system administrator sets an operation priority order. Similar structures to those shown in FIG. 2 are represented by identical reference numerals and the detailed description thereof is omitted.

As shown in FIG. 7, an OLT 201 includes an operation interface 103, a processing unit 202, an ODN interface 204, a random access memory 206 and a microprocessor 105.

The processing unit 202 processes data supplied from the operation interface 103 and ODN interface 204, determines QoS, i.e., a priority order, at the PON layer in accordance with IP layer information of the received data (IP packet) received via the operation interface 103, assigns LLID representative of a transmission destination ONU to the received data, and generates a PON frame by adding LLID to the data. The processing unit 202 includes an IGMP snooping module 113 and an LLID assignment module 111.

IGMP is an Internet group management protocol and is one subprotocol of a TCP/IP protocol group. IGMP permits participation of an Internet host to multicast, i.e., is used by an IP host to report a group relation to adjacent multicast routers. IGMP snooping is used for snooping a message of an IGMP format and extracting corresponding IGMP information.

The IGMP snooping module 113 of the processing unit 202 snoops received data, extracts a group address of multicast from an IGMP message as IP layer information, and writes it in an IP layer information—LLID table stored in the random access memory 206.

In accordance with the extracted IP layer information, the LLID assignment module 111 of the processing unit 202 assigns an optical priority order assigning LLID to the data, stores it in the IP layer information—LLID table, and transmits data of multicast corresponding to LLID to the ODN interface.

The ODN interface 204 transmits optical data received from ONU and processed by the processing unit 102 as a data frame, i.e., an LLID added PON frame, to ONU 20 in accordance with an optical transfer priority order corresponding to LLID of the PON frame to thereby control the priority order at 117 at a transmission stage. Priority control relying upon a queue is one of priority order control methods at the ODN interface. As shown in FIG. 7, the ODN interface 204 has each queue for storing a corresponding data stream, and QoS control is realized by setting a different priority order to each queue.

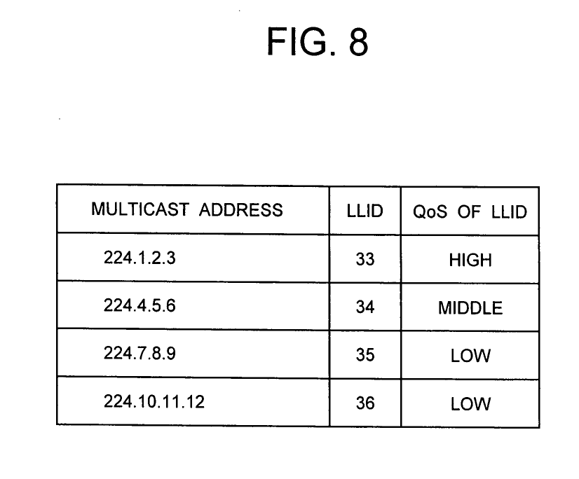

The random access memory 206 stores data under operation by OLT. The random access memory 206 stores one IP layer information—LLID table. The IP layer information—LLID table stores a correspondence among a group address of multicast of received data, and an LLID value and QoS parameter corresponding to the group address, and is used for assigning LLID and a QoS priority order of LLID to a multicast data stream. FIG. 8 shows an example of the IP layer information—LLID table.

FIG. 8 shows the IP layer information—LLID table for QoS control relying upon a group address of multicast (abbreviated to “multicast group address”), stored in the random access memory 206 of OLT 201 of the second embodiment of the present invention. The IP layer information—LLID table includes three items: “multicast group address”, “LLID” and “QoS of LLID”. As shown in FIG. 8, if the IGMP snooping module 113 of OLT 201 snoops that a group address of data belonging to multicast is “224.1.2.3”, the group address of multicast is written in the “multicast group address” item. Thereafter, the multicast LLID assignment module 111 of OLT 201 determines that QoS of LLID of the group address is “high” and assigns “33” to the group address as LLID, in accordance with predetermined rules. It is obvious that the orders of assigning LLID and determining QoS of LLID may be the same or may vary with circumstances. The predetermined rules may be determined by a system administrator.

As described above, even a QoS parameter is set at the IP layer to an original multicast packet, OLT 201 may perform transfer of QoS of a multicast packet in PON. The IGMP snooping module 113 of OLT 201 snoops the IGMP message shown in FIG. 4 and if a multicast group address “224.1.2.3” is extracted from the IGMP message, a system administrator assigns, for example, “33” to the multicast group address as LLID, and determines correspondingly that a priority order of LLID “33” is “high”. This assignment is recorded in the IP layer information—LLID table in the random access memory 103 of OLT 201. Upon reception of a multicast packet stream “224.1.2.3” transmitted from the upper level network and IPTV server 10 via the operation interface 103, the LLID “33” added multicast packet “224.1.2.3” is transmitted to the ODN interface 204 at the priority degree “high” in PON to thereby ensure the priority order of the multicast data.

### Third Embodiment

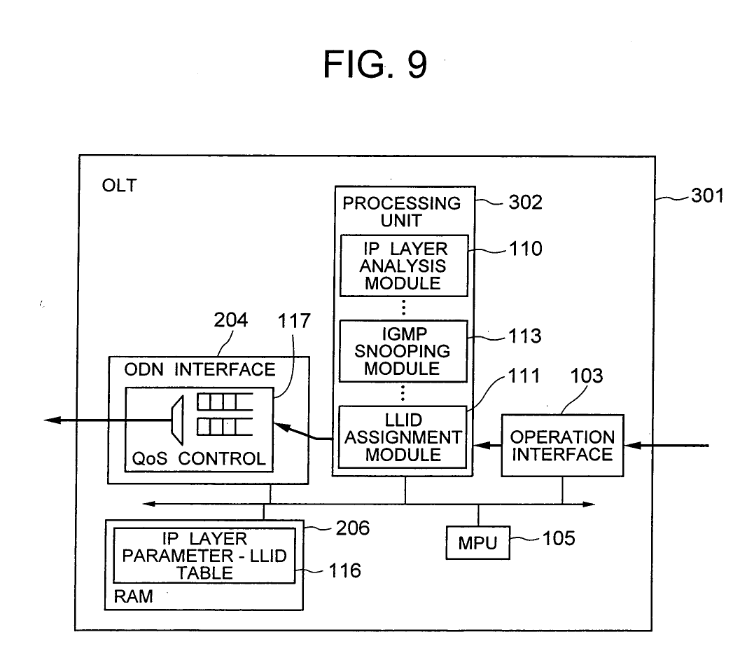

FIG. 9 is a block diagram illustrating direct mapping and showing the structure of OLT of a PON system according to the third embodiment of the present invention. The third embodiment shown in FIG. 9 is applied to a network in which although a communication administrator sets an operation priority order, an ISP sets also an operation priority order. Similar structures to those shown in FIGS. 2 and 7 are represented by identical reference numerals and the detailed description thereof is omitted.

As shown in FIG. 9, an OLT 301 includes an operation interface 103, a processing unit 302, an ODN interface 204, a random access memory 206 and a microprocessor 105.

The processing unit 302 processes data supplied from the operation interface 103 and ODN interface 204, determines QoS, i.e., a priority order, at the PON layer in accordance with IP layer information of the data (IP packet) received via the operation interface 103, assigns LLID representative of a transmission destination ONU to the received data, and generates a PON frame by adding LLID to the data. The processing unit 302 includes an IGMP snooping module 113, an IP layer analysis module 110 and an LLID assignment module 111.

The IP Layer analysis module 110 of the processing unit 302 analyzes an IP message header of received data and extracts IP layer information of the data from the IP message header. If the received data is multicast data, QoS at the IP layer is extracted from the IP message header as IP layer information.

The IGMP snooping module of the processing unit 302 snoops the received data, extracts a group address of multicast from an IGMP message as IP layer information, and writes it in an IP layer information—LLID table stored in the random access memory 206.

In accordance with the extracted IP layer information, the LLID assignment module 111 of the processing unit 302 assigns an optical priority order assigning LLID to the data, stores it in the IP layer information—LLID table, and transmits data of multicast corresponding to LLID to the ODN interface.

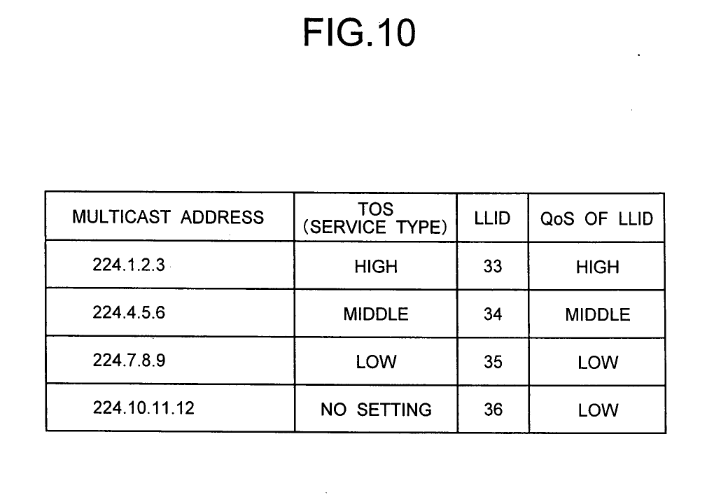

The random access memory 206 stores data under operation by OLT. The random access memory 206 stores one IP layer information—LLID table. FIG. 10 shows an example of the IP layer information—LLID table.

FIG. 10 shows the IP layer information—LLID table for QoS control relying upon a multicast group address and a TO/S value, stored in the random access memory 206 of OLT 301 of the second embodiment of the present invention. The IP layer information—LLID table includes four items: “multicast group address”, “IP layer QoS”, “LLID” and “QoS of LLID”. As shown in FIG. 10, if the IGMP snooping module 113 of OLT 301 snoops that a group address of IGMP data is “224.1.2.3”, the group address of multicast is written in the “multicast group address” item. Thereafter, if the IP layer QoS is “high”, the multicast LLID assignment module 111 of OLT 301 assigns “33” to the group address as LLID and determines that the priority order of LLID “33” is “high”, in accordance with predetermined rules. It is obvious that the orders of assigning LLID and determining QoS of LLID may be the same or may vary with circumstances. The predetermined rules may be determined by a system administrator. FIG. 10 shows the IP layer information—LLID table only by way of example. A system administrator determines LLID assignment for multicast LLID and QoS rules.

As described above, in order for the PON system to provide QoS transfer of a multicast packet, the IGMP snooping module 113 of OLT 301 snoops the IGMP message shown in FIG. 3 and extracts a multicast group address “224.1.2.3” from the IGMP message. Then, in accordance with administrator rules such as setting that the IP layer QoS of the multicast packet is “high”, the system assigns, for example, “33” to the multicast group address as LLID and determines correspondingly that the priority order of LLID “33” is “high”. Upon reception of a multicast packet stream “224.1.2.3” transmitted from the upper level network and IPTV server 10 via the operation interface 103, OLT 301 transmits the multicast packet stream “224.1.2.3” to the ODN interface 204 at the priority degree “high” in PON.

### Fourth Embodiment

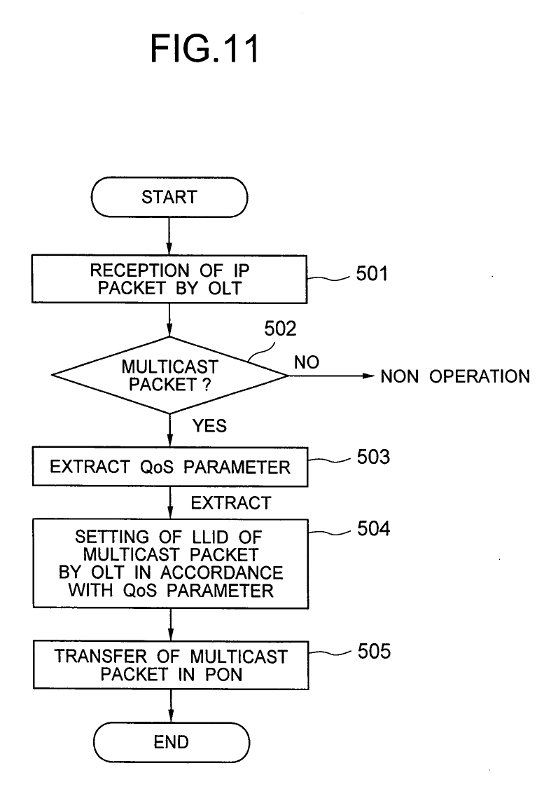

With reference to FIG. 11, description will be made on a method of controlling quality of service of IP packets in a PON system according to the fourth embodiment of the present invention.

FIG. 11 is a flow diagram illustrating a method of controlling quality of service of an IP packet in the PON system according to the fourth embodiment of the present invention.

As shown in FIG. 11, OLT receives an IP packet transmitted from an external network via the operation interface (Step 501), and thereafter it is judged whether the received IP packet is a multicast packet (Step 502). If the received IP packet is a multicast packet, a QoS parameter of the IP packet at the IP layer is extracted as IP layer information (Step 503). OLT assigns LLID to the multicast packet in accordance with the QoS parameter at the IP layer (Step 504), and the multicast packet is transferred in PON in accordance with the priority order of the assigned LLID (Step 505).

In the method of controlling quality of service of IP packets in a PON system illustrated in FIG. 11, one example that received data is a multicast packet has been described. The present invention is not limited thereto, but various modifications may be made relative to OLT of the PON system of the first to third embodiments and the method of controlling quality of service of an IP packet in the PON system of the fourth embodiment.

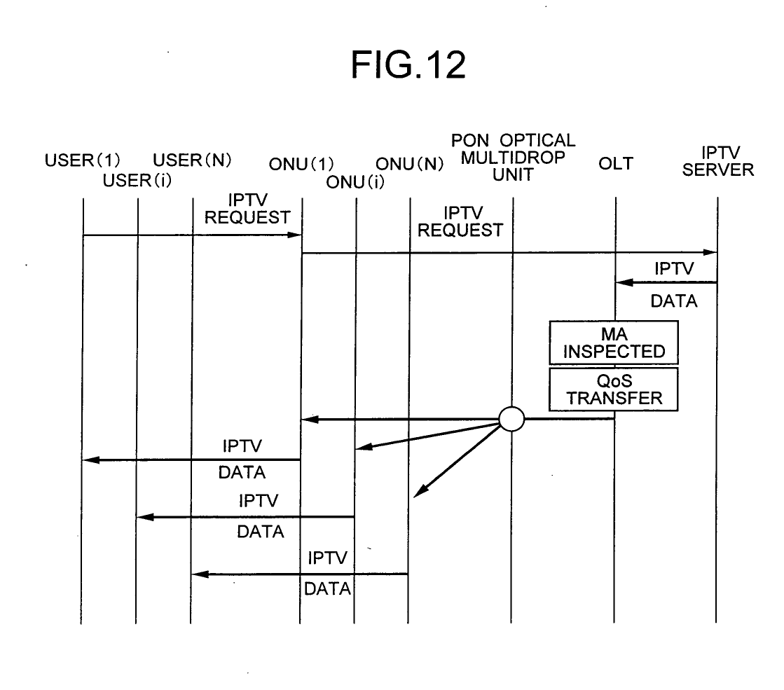

With reference to FIG. 12, description will be made on a message flow in the whole system of the present invention.

FIG. 12 shows a message flow of the whole system of the present invention. When an end user desires to view a television program, an “IPTV request” is issued which is transferred to the IPTV server via the PON system. The IPTV server transmits data of the television program, which is a multicast data stream, toward the end user. Upon reception of the multicast data stream, OLT confirms a multicast group address of the multicast data stream, and thereafter assigns LLID and corresponding LLID QoS to the multicast data stream. In this manner, QoS of transfer of the multicast data stream in PON is ensured.

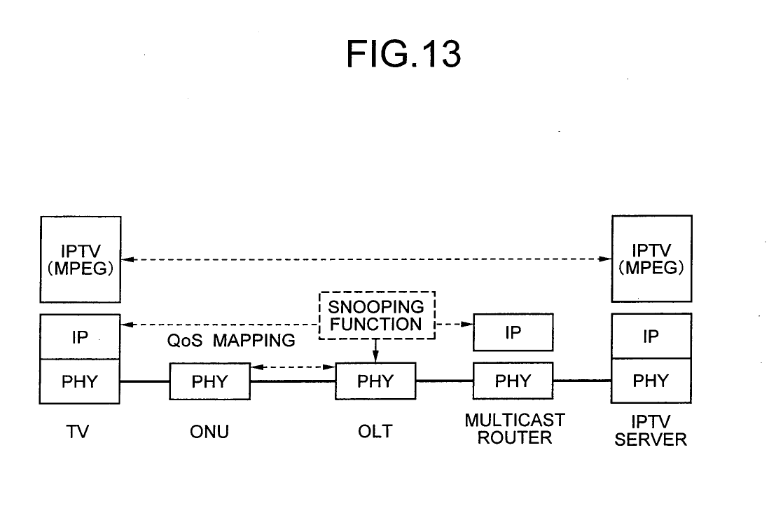

The first to fourth embodiments of the present invention have been described. Next, with reference to FIG. 13, description will be made on how QoS control is realized in the PON system adopting the methods of the first to fourth embodiments of the present invention.

FIG. 13 is a schematic diagram showing analysis of a QoS control state of the present invention made from the viewpoint of a protocol stack. FIG. 13 shows a protocol stack structure of an IPTV server, a multicast router, an OLT, an ONU, and a television (TV). QoS control is performed at the IP layer in order to realize QoS transfer from the IPTV server to the television. The IPTV server node ensures QoS down to the multicast router node and further down to the television node. However, since the protocol stack of the OLT node and ONU node does not contain the IP layer protocol, QoS control at the IP layer cannot be conducted. Namely, if collision occurs while data passes through the OLT node and ONU node, QoS of data is not ensured. According to the present invention, however, setting of IP layer information (e.g., IP layer QoS) is mapped to the OLT node and ONU node to allow QoS control of optical data in the physical protocol stack. It is therefore possible to ensure QoS of data at the OLT and ONU nodes.

As described above, in order to control quality of service of downward IP data stream transfer in a PON system, the present invention adopts a method basing upon mapping from quality of service management at the network layer to quality of service management at the physical layer. In other words, according to the present invention, by realizing mapping from IP layer information (e.g., IP Layer QoS) to QoS control at the physical layer in the PON system, QoS control of an IP packet can be performed in the PON system.

The first to fourth embodiments of the present invention have been described in detail. The present invention is not limited thereto, but those skilled in the art can make various modifications under particular situations.

For example, although EPON has been described illustratively in all the first to fourth embodiments, it is obvious that the present invention is applicable to other passive optical networks (PON) such as ATM based passive optical networks (APON) and giga-bit passive optical networks (GPON). In this case, a virtual channel identifier (VPI) in an APON system and a virtual channel identifier (VPI) and a port number (Port ID) in a GPON system correspond to the logic link identifier (LLID) in an EPON system described in detail in the first to fourth embodiments. Therefore, the logic ling identifier (LLID) in the EPON system, virtual channel identifier (VPI) in the APON system, and virtual channel identifier (VPI) and port number (Port ID) in the GPON system are collectively called LINK ID. “LINK ID” is an identifier indicating ONU uniqueness and operation connection uniqueness. In one PON system, a different LINK ID is assigned to a different ONU or a different operation connection. LINK ID is adopted in a PON system having a one-point or multipoint structure and ensures that each particular ONU can receive only data belonging to ONU in downward multicast transfer.

It should be further understood by those skilled in the art that although the foregoing description has been made on embodiments of the invention, the invention is not limited thereto and various changes and modifications may be made without departing from the spirit of the invention and the scope of the appended claims.

1. An optical line terminal (OLT) in a passive optical network (PON) system having an optical distribution network (ODN) and at least one optical network unit (ONU), comprising:
a processing unit for determining QoS, i.e., a priority order, at a PON layer in accordance with IP layer information of received data, and assigning a LINK ID to said data.

2. The optical line terminal in a passive optical network according to claim 1, wherein said IP layer information is a reception address.

3. The optical line terminal in a passive optical network according to claim 1, wherein said IP layer information is QoS at an IP layer.

4. The optical line terminal in a passive optical network according to claim 1, wherein said IP layer information is a reception address and QoS at an IP layer.

5. The optical line terminal in a passive optical network according to claim 2, wherein said reception address is a multicast group address.

6. The optical line terminal in a passive optical network according to claim 1, further comprising an ODN interface for receiving data assigned with said LINK ID by said processing unit, performing a priority order control in accordance with said LINK ID, and transmitting said data to the optical distribution network.

7. The optical line terminal in a passive optical network according to claim 1, wherein said processing unit comprises:
an IP layer analysis module for analyzing an IP message header of said received data and extracting a reception address and/or QoS at an IP layer as the IP layer information; and
a LINK ID assignment module for assigning a priority order assigning LINK ID to said data in accordance with the extracted IP layer information.

8. The optical line terminal in a passive optical network according to claim 1, wherein said processing unit comprises:
an IGMP snooping module for snooping an IGMP message in said received data and extracting a multicast group address in said IGMP message as the IP layer information; and
a LINK ID assignment module for assigning a priority order assigning LINK ID to said data.

9. The optical line terminal in a passive optical network according to claim 8, wherein said processing unit further comprises:
an IP layer analysis module for analyzing an IP message header in said received data, and if said received data is multicast data, extracting QoS at an IP layer in said IP message header as the IP layer information.

10. The optical line terminal in a passive optical network according to claim 1, further comprising an IP layer information—LINK ID table for storing a correspondence among said IP layer information of said received data, said LINK ID and QoS at said PON layer.

11. An optical line terminal in a passive optical network (PON) system having an optical distribution network (ODN) and at least one optical network unit (ONU), wherein:
the optical line terminal comprises a memory, an operation interface for receiving an IP packet, a processing unit for generating a PON frame by adding a LINK ID representative of a transmission destination ONU to said IP packet, and an ODN interface for transmitting said PON frame;
said memory has a table for storing a correspondence among IP layer information, a transfer priority order, i.e., QoS, of said PON frame, and said LINK ID;
said processing unit detects header information of a received IP packet, determines a transfer priority order and said LINK ID of said PON frame for said IP packet, in accordance with said header information and said table, and generates said PON frame by adding said LINK ID; and
said ODN Interface transmits said PON frame in accordance with said transfer priority order corresponding to said LINK ID of said PON frame.

12. A method of controlling quality of service of an IP packet in a passive optical network system having an optical distribution network (ODN), an optical line terminal (OLT) and at least one optical network unit (ONU), the method comprising a step of:
(a) determining QoS, i.e., a priority order, at a PON layer in accordance with IP layer information of received data, and assigning a LINK ID to said data.

13. The method of controlling quality of service of an IP packet in a passive optical network according to claim 12, wherein said IP layer information is a reception address and/or QoS at an IP Layer.

14. The method of controlling quality of service of an IP packet in a passive optical network according to claim 13, wherein said reception address is a multicast group address.

15. The method of controlling quality of service of an IP packet in a passive optical network according to claim 12, further comprising a step of:
(b) performing priority order control in accordance with said LINK ID and transmitting said data to the optical line terminal.

16. The method of controlling quality of service of an IP packet in a passive optical network according to claim 12, wherein said step (a) comprises:
an IP layer analysis step of analyzing an IP message header of said received data and extracting a reception address and/or QoS at an IP layer as the IP layer information; and
a LINK ID assignment step of assigning a priority order assigning LINK ID to said data in accordance with the extracted IP layer information.

17. The method of controlling quality of service of an IP packet in a passive optical network according to claim 12, wherein said step (a) comprises:
an IGMP snooping step of snooping an IGMP message in said received data and extracting a multicast group address in said IGMP message as the IP layer information; and
a LINK ID assignment step of assigning a priority order assigning LINK ID to said data.

18. The method of controlling quality of service of an IP packet in a passive optical network according to claim 17, wherein said step (a) further comprises an IP layer analysis step of analyzing an IP message header in said received data, and if said received data is multicast data, extracting QoS at an IP layer in said IP message header as the IP layer information.

19. The method of controlling quality of service of an IP packet in a passive optical network according to claim 12, further comprising a step of storing a correspondence among said IP layer information of said received data, said LINK ID and QoS at said PON layer.

20. A passive optical network system having an optical distribution network (ODN), an optical line terminal (OLT) and at least one optical network unit (ONU), wherein said optical line terminal comprises at least a processing unit for determining QoS, i.e., a priority order, at a PON layer in accordance with IP layer information of received data, and assigning a LINK ID to said data.

21. The passive optical network system according to claim 20, wherein said optical line terminal further comprises an ODN interface for receiving data assigned with said Link ID by said processing unit, performing a priority order control in accordance with said LINK ID, and transmitting said data to the optical distribution network.
